(19) United States
(12) Patent Application Publication
(10) Pub. No.: US 2008/0201572 A1
(43) Pub. Date: Aug. 21, 2008

(54) Method and system for uniformizing product data embedded in a computer platform

(75) Inventor: Wen-Hsin Shih, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/709,432

(22) Filed: Feb. 21, 2007

(51) Int. Cl. G06F 15/177

(52) U.S. Cl. 713/2

(57) ABSTRACT

A method uniformizes product data embedded in a computer platform equipped with a first-type control unit stored with first product data, and a second-type control unit stored with second product data. The method includes recording a first time value when the first product data are modified; recording a second time value when the second product data are modified; reading the first and second time values when either one of a power-on procedure and a resetting procedure is performed on the computer platform; comparing the first time value with the second time value and determining whether the first time value is identical to the second time value; and updating one of the first product data and the second product data having an earlier one of the first and second time values with the other if the first time value is determined to be not equal to the second time value.

### BACKGROUND OF THE INVENTION

1. Field of the Invention

This invention relates to information technology (IT), and more particularly, to a method and system for uniformizing product data embedded in a computer platform having a baseboard management controller (BMC) module, such as a network server, for providing the network server with an embedded product data uniformization handling function.

2. Description of Related Art

A baseboard management controller (BMC) is a server-specific management control unit that is widely utilized on network-based computer platforms such as servers and implemented with a control chip for installation on the baseboard of the server. In practice, the BMC module is integrated together with the BIOS (Basic Input/Output System) module on the server's baseboard for providing the server's baseboard with a set of management control functions, including power management, heat-dissipation fan control, operating system status monitoring, to name just a few. Fundamentally, the main purpose of BMC functionality is to ensure that the server's baseboard can operate normally.

In the manufacture and distribution of network servers, both the manufacturer and the dealer often need to embed a set of product data in the network server, where the product data may include product name, serial number, specification, information about the manufacturer, to name a few. This practice allows the end user or maintenance personnel to learn the product data about the network server simply by retrieving the embedded product data from the network server. In practice, the product data can be either embedded in the SMBIOS (System Management BIOS) area of the BIOS module, or in the FRU (Field Replaceable Unit) data storage area of the BMC module.

Moreover, the embedded product data can be modified by the manufacturer and dealer at any stages of manufacture and distribution whenever the product data is updated. When the SMBIOS-embedded product data is updated, the BMC-FRU-embedded product data should also be updated with the same copy of product data, so as to make the two copies of product data uniformized in content. However, the actual situation is usually that the update of product data is only directed to either BIOS or BMC, but not both. For example, the manufacturer may just update the SMBIOS-embedded product data while leaving the BMC-FRU-embedded product data intact, or vice versa. In this case, the BMC-FRU-embedded product data will be different in content from the SMBIOS-embedded product data; and thus, when the network server needs maintenance, the maintenance personnel may retrieve the old version of product data and carry out improper maintenance work on the network server based on incorrect product data.

### SUMMARY OF THE INVENTION

It is therefore an objective of this invention to provide a method and system for uniformizing product data embedded in a computer platform, for uniformizing SMBIOS-embedded product data and BMC-FRU-embedded product data at each start of the network server, so as to allow the two copies of product data to be always uniformized and updated in content.

The method and system according to the invention are both designed for use in a computer platform having a baseboard management controller (BMC) module, such as a network server, for providing the network server with an embedded product data uniformization handling function.

The method is used for uniformizing product data embedded in a computer platform equipped with a first-type control unit and a second-type control unit, wherein the first-type control unit is stored with first product data relating the computer platform and the second-type control unit is stored with second product data relating the computer platform the method includes recording a first time value when the first product data are modified; recording a second time value when the second product data are modified; reading the first time value and the second time value when either one of a power-on procedure and a resetting procedure is performed on the computer platform; comparing the first time value with the second time value and determining whether the first time value is identical to the second time value; and if not, defining one of the first product data and the second product data having a later one of the first time value and the second time value as last modified product data, and the other one as earlier modified product data; and updating the earlier product data therein with the modified product data.

The system is used for uniformizing product data embedded in a computer platform equipped with a first-type control unit and a second-type control unit, wherein the first-type control unit is stored with first product data relating the computer platform and the second-type control unit is stored with second product data relating the computer platform. The system includes a first recording module, which records a first time value when the first product data are modified; a second recording module, which records a second time value when the second product data are modified; a reading module, which reads the first time value and the second time value when either one of a power-on procedure and a resetting procedure is performed on the computer platform; a comparison module, which compares the first time value with the second time value to determine whether the first time value is identical to the second time value; and an updating module, which updates one of the first product data and the second product having an earlier one of the first time value and the second time value with the other when the comparison module determines that the first time value is not identical to the second time value.

The method and system according to the invention are characterized by the capability of recording the respective temporal points (i.e., date and time) of the programming of two separate sets of product data into a boot controller and a baseboard management controller, such that at each start of the computer platform, the two recorded temporal points are compared to see if equal. If not, the product data with the earlier temporal point is discarded, and the product data with the late temporal point is used to update the older set of product data. This feature allows the boot controller and the baseboard management controller to always store uniformized product data.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of a system for uniformizing product data embedded in a computer platform according to the present invention;

FIG. 2 is a schematic diagram showing a modularized architecture of a system for uniformizing product data embedded in a computer platform according to the present invention; and

FIG. 3 is an activity diagram showing the activities performed by the system shown in FIG. 2 and other related entities.

### DETAILED DESCRIPTION OF PREFERRED EMBODIMENTS

The method and system for uniformizing product data embedded in a computer platform according to the invention are disclosed in full details by way of preferred embodiments in the following with reference to the accompanying drawings.

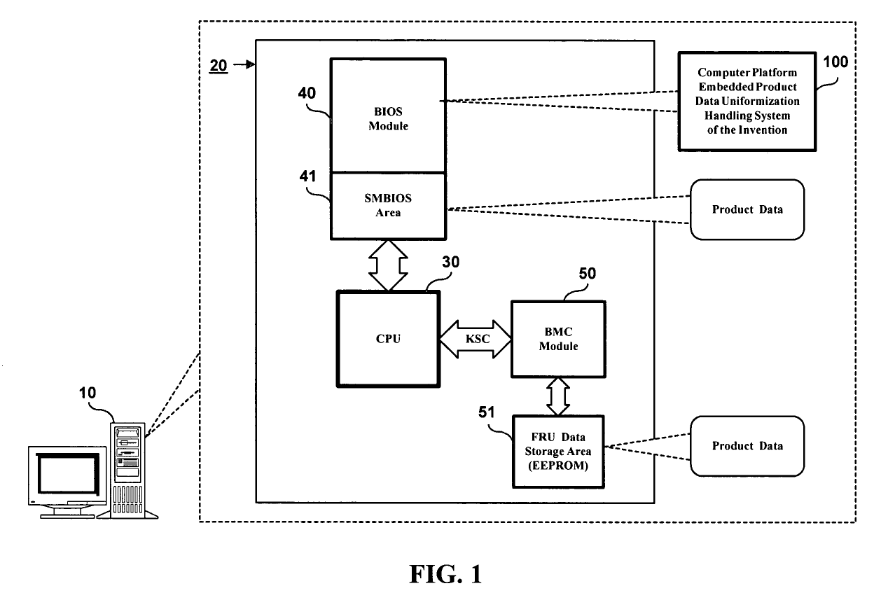

FIG. 1 is a schematic diagram showing the application of a system 100 for uniformizing product data embedded in a computer platform according to the invention. The system 100 is designed for use with a computer platform 10, such as a network server or a desktop computer, which is based on a baseboard (i.e., main circuit board) 20 that is equipped with a central processing unit (CPU) 30, a first-type control unit 40 such as a boot controller, and a second-type control unit 50 such as a baseboard management controller 50. The boot controller 40 is for example a BIOS (Basic Input/Output System) based boot controller (hereinafter referred to as “BIOS module”) which is typically implemented with program code stored in a flash memory and whose storage space includes an extended partition called SMBIOS (System Management BIOS), which is hereinafter referred to as “SMBIOS area”. The baseboard management controller 50 is for example a BMC (Baseboard Management Controller) module of an IPMI (Intelligent Platform Management Interface) specification. Typically, the BMC is implemented with a control chip and includes an EEPROM (Electrically Erasable Programmable Read-Only Memory) module to serve as an FRU (Field Replaceable Unit) data storage area 51 for storing the configuration data of various field replaceable units (i.e., system components) of the computer platform 10. Furthermore, the BMC module 50 and the CPU 30 can communicate with each other via an IPMI-compliant KCS (Keyboard Controller Style) compliant bus interface for data exchange.

In application, the user can embed a set of product data about the computer platform 10 either into the SMBIOS area 41 of the BIOS module 40, or the FRU data storage area 51 of the BMC module 50, or both. In practice, for example, the manufacturer of the computer platform 10 might embed a set of product data relating the computer platform 10 into the SMBIOS area 41 of the BIOS module 40 during the manufacturing process in factory; and later after the shipment of the computer platform 10 to a dealer, the dealer might reconfigure the computer platform 10 and then embed a corresponding set of product data into the FRU data storage area 51 of the BMC module 50. This practice will make the SMBIOS-embedded product data and the BMC-FRU-embedded product data to be inconsistent. In this case, the system 100 can uniformize these two inconsistent versions of product data by updating the older version with the newer version.

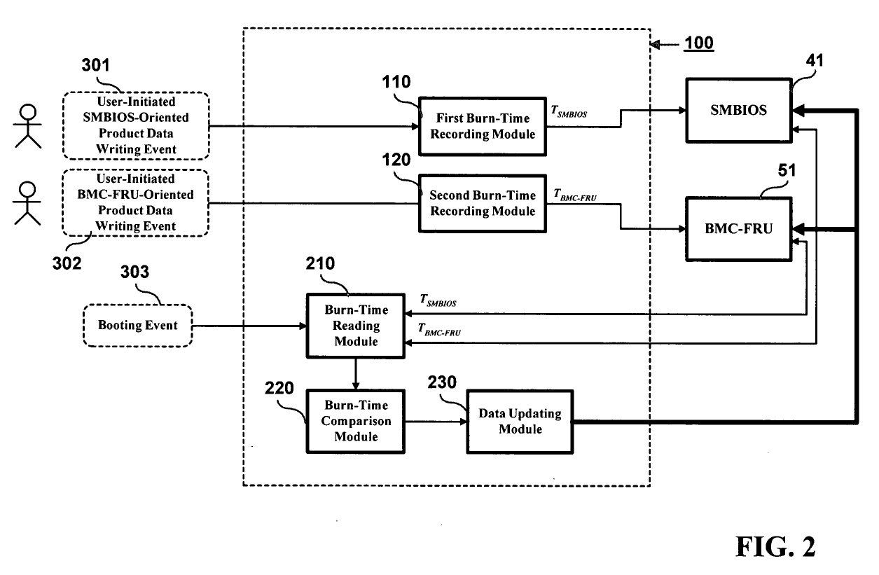

As shown in FIG. 2, the system 100 is based on a modularized architecture, which comprises a first recording module 110, a second recording module 120, a reading module 210, a comparison module 220, and an updating module 230.

The first recording module 110 responds to each occurrence of a user-initiated SMBIOS-oriented product data writing event 301 on the computer platform 10, such as when first product data PRODUCT_DATA_VER(1) are being stored into the SMBIOS area 41 of the BIOS module 40, by recording the temporal point of the SMBIOS-oriented product data writing event 301 and storing the recorded temporal point as an SMBIOS data burn-time value denoted by T_{SMBIOS}. In short, the first recording module 110 records a first time value (i.e. the SMBIOS data burn-time value T_{SMBIOS} when first product data (i.e. the first product data PRODUCT_DATA_VER(1)) are modified. Preferably, the recorded value of T_{SMBIOS} is also stored into the SMBIOS area 41 of the BIOS module 40.

The second recording module 120 responds to each occurrence of a user-initiated BMC-FRU-oriented product data writing event 302 on the computer platform 10, such as when second product data PRODUCT_DATA_VER(2) are being burned into the FRU data storage area 51 of the BMC module 50, by recording the temporal point of the BMC-FRU-oriented product data writing event 302 and storing the recorded temporal point as an BMC-FRU data burn-time value denoted by T_{BMC-FRU}. In short, the second recording module 120 records a second time value (i.e. the SMBIOS data burn-time value T_{BMC-FRU} when second product data (i.e. the first product data PRODUCT_DATA_VER(2)) are modified. Preferably, the recorded value of T_{BMC-FRU} is also stored into the FRU data storage area 51 of the BMC module 50.

The reading module 210 responds to each occurrence of a booting event 303 on the computer platform 10 (i.e., when a power-on or resetting procedure is performed on the computer platform 10) by reading the value of T_{SMBIOS} (the first time vlaue)recorded by the first recording module 110 from the SMBIOS area 41 of the BIOS module 40, and also the value of T_{BMC-FRU} (the second time value) recorded by second recording module 120 from the FRU data storage area 51 of the BMC module 50. The retrieved data (T_{SMBIOS}, T_{BMC-FRU}) are then transferred to the comparison module 220.

The comparison module 220 compares the value of T_{SMBIOS} against the value of T_{BMC-FRU} retrieved by the reading module 210 to determine whether if the two values are identical. If T_{SMBIOS} is earlier than T_{BMC-FRU}, then an SMBIOS-oriented update enable message is issued to the updating module 230; and whereas if T_{SMBIOS} is later than T_{BMC-FRU}, then a BMC-FRU-oriented update enable message is issued to the updating module 230.

The updating module 230 responds to either the SMBIOS-oriented update enable message or the BMC-FRU-oriented update enable message from the comparison module 220 by first discarding the product data stored in either the SMBIOS area 41 of the BIOS module 40 or the FRU data storage area 51 of the BMC module 50 that has an earlier temporal point of burn-time, and then updating it with the product data that has a later temporal point of burn-time. For example, if T_{SMBIOS} is earlier than T_{BMC-FRU}, then the first product data PRODUCT_DATA_VER(1) embedded in the SMBIOS area 41 of the BIOS module 40 is discarded, and then the second product data PRODUCT_DATA_VER(2) currently embedded in the FRU data storage area 51 of the BMC module 50 is duplicated into the SMBIOS area 41 of the BIOS module 40; and vice versa. In addition, the updating module 230 can further include a checksum inspecting function for inspecting whether a new checksum the newest version of product data, PRODUCT_DATA_VER(1) or PRODUCT_DATA_VER(2), is correct, so as to identify the integrity of the newest version of product data used for the update.

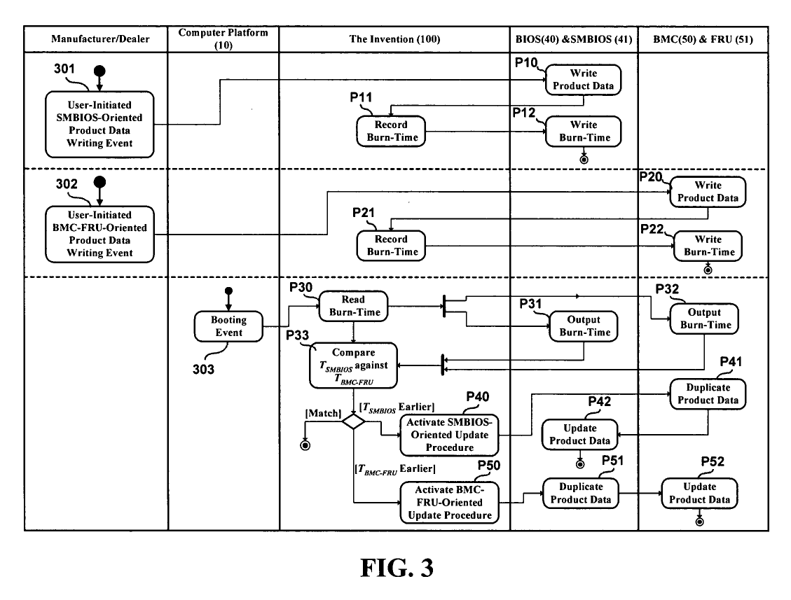

The following is a detailed description of a practical application example of the computer platform embedded product data uniformization handling system of the invention 100 during actual operation, with reference to the activity diagram of FIG. 3.

In this application example, it is assumed that the first product data PRODUCT_DATA_VER(1) are burned into the SMBIOS area 41 of the BIOS module 40 by the manufacturer in factory, thus causing the occurrence of a SMBIOS-oriented product data writing event 301 on the computer platform 10. This event causes PRODUCT_DATA_VER(1) to be written into the SMBIOS area 41 of the BIOS module 40 (as the activity P10 shown in FIG. 3), and whereupon the first recording module 110 is activated to record the temporal point of the SMBIOS-oriented product data writing event 301 to a variable T_{SMBIOS} (as the activity P11 shown in FIG. 3) and then store the value of T_{SMBIOS} into the SMBIOS area 41 of the BIOS module 40 (as the activity P12 shown in FIG. 3). Thereafter, if any person embed a new version of product data into the SMBIOS area 41, the same procedures P10, P11, and P12 will be repeated again to update the value of T_{SMBIOS}.

Subsequently, it is assumed that the computer platform 10 is later shipped by the manufacturer to a dealer, where the second product data PRODUCT_DATA_VER(2) are burned into the FRU data storage area 51 of the BMC module 50 by the dealer, thus causing the occurrence of a BMC-FRU-oriented product data writing event 302 on the computer platform 10. This event causes PRODUCT_DATA_VER(2) to be written into the FRU data storage area 51 of the BMC module 50 (as the activity P20 shown in FIG. 3), and whereupon the second recording module 120 is activated to record the temporal point of the BMC-FRU-oriented product data writing event 302 to a variable T_{BMC-FRU} (as the activity P21 shown in FIG. 3) and then store the value of T_{BMC-FRU} into the FRU data storage area 51 of the BMC module 50 (as the activity P22 shown in FIG. 3). Thereafter, if any person embed a new version of product data into the FRU data storage area 51, the same procedures P20, P21, and P22 will be repeated again to update the value of T_{BMC-FRU}.

Thereafter, whenever the computer platform 10 is powered on or reset that causes the occurrence of a booting event 303, it will activate the reading module 210 to read the recorded value of T_{SMBIOS} from the SMBIOS area 41 of the BIOS module 40 and the recorded value of T_{BMC-FRU} from the FRU data storage area 51 of the BMC module 50 (as the activity P30 shown in FIG. 3). This action causes the BIOS module 40 to output and transfer the value of T_{SMBIOS} to the comparison module 220 (as the activity P31 shown in FIG. 3), and meanwhile causes the BMC module 50 to output and transfer the value of T_{BMC-FRU}. to the comparison module 220 (as the activity P32 shown in FIG. 3). Next, the comparison module 220 is activated to compare the value of T_{SMBIOS} with the value of T_{BMC-FRU} to determine whether the two values are identical (as the activity P33 shown in FIG. 3).

If T_{SMBIOS}=T_{BMC-FRU}, it indicates that the SMBIOS-embedded product data and the BMC-FRU-embedded product data are two identical copies that require no uniformization, and therefore the procedure is ended. However, if T_{SMBIOS}<T_{BMC-FRU}, it indicates that T_{SMBIOS} is earlier than T_{BMC-FRU}, and thus the reading module 210 is activated to perform a SMBIOS-oriented update procedure (as the activity P40 shown in FIG. 3), which first duplicates a copy of the current product data stored in the FRU data storage area 51 of the BMC module 50 (as the activity P41 shown in FIG. 3); and then transfer the duplicated copy of product data to the SMBIOS area 41 of the BIOS module 40 (as the activity P42 shown in FIG. 3), whereby the product data stored in the SMBIOS area 41 of the BIOS module 40 is updated with the product data from the FRU data storage area 51 of the BMC module 50. During this process, the updating module 230 can also perform a checksum inspecting procedure to inspect the correctness and completeness of the newest version of product data that is used for the update. The procedure is then ended.

On the other hand, if T_{SMBIOS}>T_{BMC-FRU}, it indicates that T_{BMC-FRU} is earlier than T_{SMBIOS}, and thus the reading module 210 is activated to perform a BMC-FRU-oriented update procedure (as the activity P50 shown in FIG. 3), which first duplicates a copy of the current product data stored in the SMBIOS area 41 of the BIOS module 40 (as the activity P51 shown in FIG. 3); and then transfer the duplicated copy of product data to the FRU data storage area 51 of the BMC module 50 (as the activity P52 shown in FIG. 3), whereby the product data in the FRU data storage area 51 is updated with the product data in the SMBIOS area 41. The procedure is then ended.

In conclusion, the invention provides a method and system which is designed for use by a computer platform for providing an embedded product data uniformization handling function, and which is characterized by the capability of recording the respective temporal points (i.e., date and time) of the programming of two separate sets of product data into a boot controller and a baseboard management controller, such that at each start of the computer platform, the two recorded temporal points are compared to determine if being identical. If not, the product data with the earlier temporal point is discarded, and the product data with the later temporal point is used to update the older product data. This feature allows the boot controller and the baseboard management controller to always store uniformized sets of product data. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for uniformizing product data embedded in a computer platform equipped with a first-type control unit and a second-type control unit, wherein the first-type control unit is stored with first product data relating the computer platform and the second-type control unit is stored with second product data relating the computer platform, the method comprising:
recording a first time value when the first product data are modified;
recording a second time value when the second product data are modified;
reading the first time value and the second time value when either one of a power-on procedure and a resetting procedure is performed on the computer platform;
comparing the first time value with the second time value and determining whether the first time value is identical to the second time value; and if not, defining one of the first product data and the second product data having a later one of the first time value and the second time value as last modified product data, and the other one as earlier modified product data; and
updating the earlier product data therein with the modified product data.

2. The method of claim 1 further comprising:
inspecting whether a checksum of the updated product data is correct, so as to identify the integrity of the first product data and the second product data.

3. A system for uniformizing product data embedded in a computer platform equipped with a first-type control unit and a second-type control unit, wherein the first-type control unit is stored with first product data relating the computer platform and the second-type control unit is stored with second product data relating the computer platform, the system comprising:
a first recording module, which records a first time value when the first product data are modified;
a second recording module, which records a second time value when the second product data are modified;
a reading module, which reads the first time value and the second time value when either one of a power-on procedure and a resetting procedure is performed on the computer platform;
a comparison module, which compares the first time value with the second time value to determine whether the first time value is identical to the second time value; and
an updating module, which updates one of the first product data and the second product having an earlier one of the first time value and the second time value with the other when the comparison module determines that the first time value is not identical to the second time value.

4. The system of claim 3, wherein the computer platform is a network server.

5. The system of claim 3, wherein the computer platform is a desktop computer.

6. The system of claim 3, wherein the first-type control unit is a basic input/output system-(BIOS) based boot controller.

7. The system of claim 6, wherein the BIOS-based boot controller includes a System Management BIOS (SMBIOS) based system management data storage area for storing the first product data.

8. The system of claim 7, wherein the SMBIOS-based system management data storage area is a partition in a flash memory.

9. The system of claim 3, wherein the second-type control unit is a baseboard management controller (BMC) based baseboard management controller of an intelligent platform management interface (IPMI) specification.

10. The system of claim 9, wherein the BMC-based baseboard management controller includes a field replaceable unit (FRU) data storage area for storing the second product data.

11. The system of claim 10, wherein the FRU data storage area is a partition in an electrically erasable programmable read-only memory (EEPROM) unit.

12. The system of claim 3, wherein the first-type control unit and the second-type control unit communicate with each other via a keyboard controller style (KCS) based bus interface.

13. The system of claim 3, wherein the updating module includes a checksum inspecting function, which inspects whether a checksum of the updated product data is correct, so as to identify the integrity of the first product data and the second product data.
